(19) United States
(12) Patent Application Publication
(10) Pub. No.: US 2009/0079660 A1
(43) Pub. Date: Mar. 26, 2009

(54) DISTRIBUTED ANTENNA SYSTEM USING OVERHEAD POWER LINES

(75) Inventor: Glenn E. Elmore, Santa Rosa, CA (US)

Correspondence Address: STAINBROOK & STAINBROOK, LLP, 412 AVIATION BOULEVARD, SUITE H, SANTA ROSA, CA, 95403, US

(73) Assignee: CORRIDOR SYSTEMS, INC., Santa-Rosa, CA (US)

(21) Appl. No.: 11/718,179

(22) PCT Filed: Oct. 28, 2005
(86) PCT No.: PCT/US2005/039404

§ 371 Date: Apr. 27, 2007

Related U.S. Application Data
(60) Provisional application No. 60/623,291, filed on Oct. 28, 2004.

(51) Int. Cl. H01Q 1/00

(52) U.S. Cl. 343/904

(57) ABSTRACT

A distributed antenna system having a transport portion including at least one overhead power line for transmitting system information along its length, and a distribution portion including at least one local access point disposed along the length of the power line for providing local access to information transported by the transport portion.

### BACKGROUND OF THE INVENTION

1. Technical Field

The present invention relates generally to telecommunications systems, and more particularly to a novel method for utilizing overhead transmission lines for both the transport and distribution of information.

2. Background Art

As capacity and coverage requirements for personal and mobile communications have escalated, the original flooding approach used by cellular mobile service providers, that of attempting total coverage of a relative large area surrounding a centralized cellular base station site, has fallen increasingly short of requirements. Although the quantity of installed cell sites has steadily increased, both in the US and worldwide, demand has increased faster. Due to the length of the average radio propagation path and the large amount of associated attenuation in typical rural, suburban or urban environments, the cost of increasing either information capacity of served areas or coverage into unserved areas can be prohibitive. Additionally, in many locations, the availability of suitable sites is dwindling and new site procurement is becoming more expensive or even unattainable due to local zoning restriction and regulation.

In the United States, an estimated $5 billion is invested annually to solve these problems. Worldwide, approximately $18 billion is invested each year. One approach taken to solve these problems has been to increase the density of access sites (Base stations) in order to both reduce the average path length and provide service to more users per unit area. But due to the cost for both equipment and additional back haul, this is an unacceptably expensive solution.

More recently distributed antenna systems (DAS) have been used to solve these problems. These operate by providing multiple antennas for each base station. The modulated information is distributed either by a transmission line, fiber or coax, or by over-the-air wireless methods (active repeater). DAS has the advantage of not incurring additional back haul cost and a limited increase in equipment cost while providing multiple points of access for end users. Because of the multiple antenna sites, radio paths tend to be shorter and incur less attenuation which improves the link margin. These characteristics have direct economic advantages over previous methods. These improvements in link margin can be used to increase either or both capacity and coverage compared to traditional centralized cellular base architectures. However, both the DAS transport infrastructure, whether wired (including optical fiber) or wireless, and the problem of siting the multiple DAS antennas still must be solved. Site location, rights-of-way, zoning and other issues may well dominate the economics of a business case for a DAS system. At the same time, additional expenditures must be made to build out both transport infrastructure and suitable hardware for each of the distributed antenna locations.

In addition to the hardware and back haul costs already mentioned, a considerable portion of the cost of coverage addition and extension, independent of the type, has been due to the expense of coverage planning and the analysis of local terrain and environment. For all of these reasons, existing DAS solutions have had limited success.

A more effective and less expensive solution to these coverage and capacity issues is needed.

### DISCLOSURE OF THE INVENTION

To meet the above-described needs, there is disclosed herein a distributed antenna system using overhead power lines having high capacity, which can provide improved coverage, hole filling, and better communications for telephones and information devices and services, either fixed or mobile, at a much lower cost than existing methods. Transport is accomplished through the use of surface wave transmission mode over a single power line conductor and distribution is enhanced by the ubiquity, and economy of using a power line conductor as the supporting structure to promote local wireless access at one or many different locations along the power line.

The inventive system exploits the existing infrastructure of medium-voltage, overhead power lines to extend wireless coverage footprints efficiently and selectively. The existing power lines are used for DAS transport at greatly reduced expense in comparison to previous wired or wireless transport hardware. The power lines are well located in terms of radio propagation to end users and are used as sites for local distribution antennas, reducing or eliminating the costs associated with permitting and acquisition of additional base stations or DAS hardware. Site zoning and permitting costs may also be avoided.

Furthermore, this invention can allow existing customer premises/provided equipment (CPE) to operate normally and with no modification or alteration. The DAS provided by this invention is effectively transparent to the user. Because the system is linear, it is able to support a variety of cellular standards, time-division multiple access (TDMA), code-division multiple access (CDMA), second and third generation systems (2G/3G), as well as new ones (e.g., 4G) not yet instituted. Multiple standards can be supported by a single DAS system. It is also possible to run services other than cellular services over the same distribution hardware: WiFi, WiMax or even UWB communications may be run in parallel with cellular communications. Simultaneous point-to-point communications for utility company or third party uses are possible. Distribution for other DAS or different systems, perhaps from a different sector of the same base or from a different base, may be transported simultaneously.

Interface to the donor Base station can be simple, either by direct connection or wireless means.

The coverage area that results from the DAS of the present invention generally extends in a cigar-shaped swath, approximately centered on the power line, though somewhat longer than the length of the line segment. Local antennas may be placed as desired to create sufficient coverage of this area, which usually coincides with highway corridors or high user traffic areas, which are typically very desirable target areas. A segment can be up to several miles in length and one or more miles in width.

Coverage planning for this invention is greatly simplified and the resulting coverage area is more ideally matched to the user geography. Better spectrum use and reuse is afforded by this arrangement as well.

The DAS of the present invention is faster and much less expensive to deploy than prior solutions. Network management of the coverage area is very much the same as for the traditional central base station or previous DAS solutions.

The better coverage also allows lower radiation levels and allows greater battery life for portable CPE. It can also improve link margin and information capacity such as to provide higher speed services and applications, such as imaging and video.

As will be appreciated by those with skill in the art, in addition to overhead power lines, a number of other kinds of overhead transmission lines could be employed in the present invention, including telephone lines, coaxial feeder lines, G-strings, wave guides, etc. However, because of the advantages of utilizing widespread existing infrastructure, power lines are the preferred support structure for the distributed antenna system of the present invention.

The following list, which is by no means exhaustive, sets out several principal objects and advantages of the distributed antenna system of the present invention.

It is an object of the present invention to provide a distributed antenna system using high capacity overhead power lines.

It is a further object to provide a distributed antenna system with improved coverage and hole filling.

It is still another object to provide a distributed antenna system with improved communications for fixed or mobile telephones and information devices and services.

Another object is to provide a distributed antenna system that provides communications at less cost than existing systems.

Yet another object is to provide a distributed antenna system in which transport is accomplished through the use of surface wave transmission mode over a single power line conductor.

A still further object is to provide a distributed antenna system which provides local wireless access at numerous locations along the power line.

Another object is to provide a distributed antenna system that reduces or eliminates the costs associated with permitting and acquisition of additional base stations or DAS hardware.

Another object is to provide a distributed antenna system that allows existing customer equipment to operate without modification.

Yet another object is to provide a distributed antenna system that supports a variety of cellular standards.

A further object is to provide a distributed antenna system in which communication services can be run parallel with cellular communications.

Another object is to provide a distributed antenna system which is faster and less expensive to deploy than prior art solutions.

Yet another object is to provide a distributed antenna system that utilizes lower radiation levels.

A final noteworthy, though not final object and advantage of the present invention, is to provide a distributed antenna system that facilitates greater battery life for portable CPE.

There has thus been broadly outlined the more important features of the invention in order that the detailed description that follows may be better understood, and in order that the present contribution to the art may be better appreciated. Additional objects, advantages and novel features of the invention will be set forth in part in the description as follows, and in part will become apparent to those skilled in the art upon examination of the following. Furthermore, such objects, advantages and features may be learned by practice of the invention, or may be realized and attained by means of the instrumentalities and combinations particularly pointed out in the appended claims.

Still other objects and advantages of the present invention will become readily apparent to those skilled in this art from the following detailed description, which shows and describes only the preferred embodiments of the invention, simply by way of illustration of the best mode now contemplated of carrying out the invention. As will be realized, the invention is capable of modification in various obvious respects without departing from the invention. Accordingly, the drawing and the written description of the preferred embodiment are to be regarded as illustrative in nature, and not as restrictive.

### BRIEF DESCRIPTION OF THE DRAWING

The invention will be better understood and objects other than those set forth above will become apparent when consideration is given to the following detailed description of the distributed antenna system of the present invention. Such description makes reference to the single annexed drawing, briefly described as follows:

FIG. 1 is a schematic view of the distributed antenna system of the present invention.

### BEST MODE FOR CARRYING OUT THE INVENTION

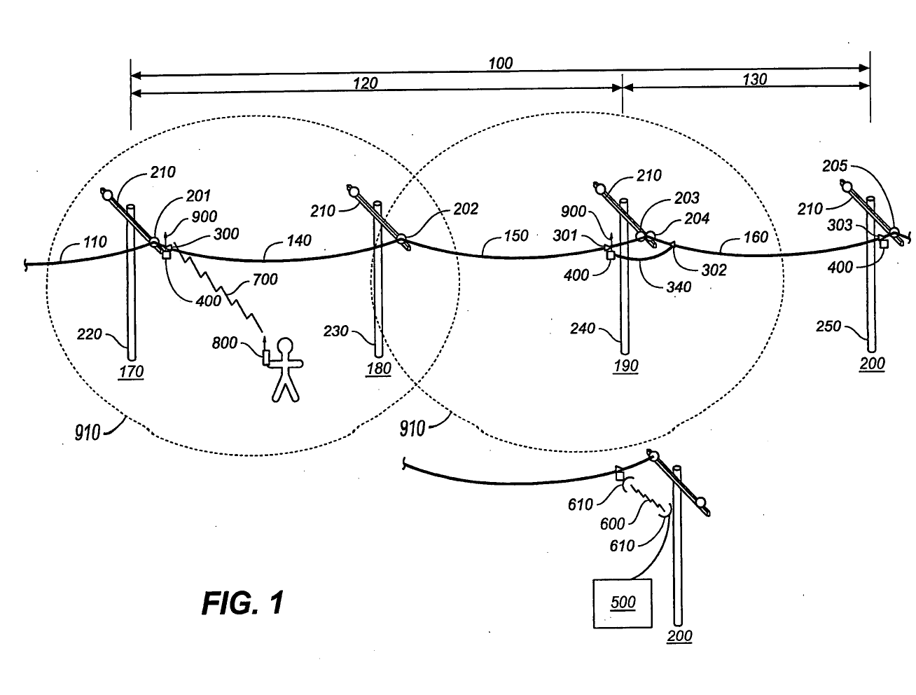

FIG. 1 is a schematic view illustrating a new and improved distributed antenna system using overhead power lines. The inventive system comprises two functional aspects: transport and distribution. Transport relates to that portion of the system that provides for the transmission and maintenance of system information capacity along the length of the line. Distribution relates to the portion or portions of the system that provide local access at one or more points along the line and at the end points.

Transport. The transport function of this invention operates by dividing a length of overhead power line 100, into one or more segments, 120, 130. Each segment includes one or more spans 140, 150, 160 of power line, having supporting structures 170, 180, 190, 200 at their respective ends. These support structures typically comprise insulators 201, 202, 203, 204, 205, cross arms 210, and poles 220, 230, 240, 250, or other physically fixed structures to support the weight of the power line and to place the power line in the span under some degree of mechanical tension. That tension causes the line to run generally parallel to the plane of the ground underneath, though having a generally catenary shape and some sag in the region between supports, 260.

Each segment, which may or may not include more than one span of power line and may or may not include intermediate supporting insulators 202 and structures, has a segment adapter device, preferably a surface wave adapter, 300, 301, 302, 303, at each end which couples electromagnetic energy to, from, or to and from the power line in a surface wave mode, as described in several pending patent applications of the present invention, which applications are identified as follows: International Pat. Appl. No. PCT/US02/15430, filed May 13, 2002, and corresponding U.S. patent application Ser. No. 10/250,625, filed Jul. 2, 2003, each entitled, Method and Apparatus for Information Conveyance and Distribution; International Pat. Appl. Ser. No. PCT/US03/39220, filed Dec. 9, 2003, and corresponding U.S. patent application Ser. No. 10/732,080, also filed Dec. 9, 2003, each entitled, Method and Apparatus for Launching a Surfacewave onto a Single Conductor Transmission Line; and U.S. patent application Ser. No. 11/134,016, filed May 20, 2005, entitled System for Launching Surfacewaves Over Unconditioned Power Lines. All of the foregoing patent applications, disclosing technology invented by the present inventor, are incorporated in their entirety by reference herein.

A surface wave adapter 301 may couple to another surface wave adapter 302 which is part of another segment. Coupling may be via a coaxial or optical cable 340 to an antenna or to any other kind of propagation medium adapter. Amplification may be associated with an adapter to allow maintenance of adequate information signal/noise power ratio to ensure overall system information capacity, however, an amplifier is not necessarily required. The preferred embodiment is to place periodic amplification 400 frequently enough within a segment or segments so as to compensate for the transmission attenuation sustained along the surface wave system to its location. Automatic gain control providing dynamic adjustment at each amplifier is provided as part of system management. The goal of this periodic amplification is to obtain the desired information capacity throughout the entire transport system and to maintain it over a range of attenuation variations caused by environmental and systemic factors. Such factors include, but are not limited to, birds or animals on the power line, rain, snow, ice, kites, or other articles on the line and so forth.

Head End Connection. For portable and mobile telephone use, known as cellular telephone, a communications connection is made between the transport portion of this invention and a central communications device 500, which is not otherwise part of this invention. This device which may be a cellular base station or other head end device, generally provides conduit for information between the DAS to external points, perhaps worldwide. This device is sometimes called a donor. The donor device may include some level of system management and it may include signal routing functions.

The connection to the head end device 600 may be made either wireless with antennas 610 or by wired means. If made by wired means, optical fiber is the preferred method since it can provide insulation from any line potential of the power lines.

Distribution. The distribution portion of this invention is located at one or more points along the length of a segment, including a segment end. Distribution is normally aggregated in a common enclosure along with transport functions at the end of a segment but it need not be. This portion serves to conduct information between communications devices at local points, herein referred to as “users,” 800, to the transport portion of the invention 100. The preferred embodiment of this portion uses an antenna 900 mounted on the power line, possibly in the same physical structure in which the adapter and amplifier used for transport are housed. By virtue of the power line height, this antenna is typically at 10-20 meters elevation above ground level and well situated for communication with local users who may be at or near ground level. The resulting radio path between the users and the local antenna 700 is of much better quality than a longer path to a more distant centralized, base station as has been used previously. This shorter path has lower attenuation (as path loss) in comparison with the longer paths used in cellular systems using a single centralized base station. As a result, CPE can be operated at lower power, can support higher information capacity services, or both. The local antenna serves to produce a coverage “footprint” 910 in its own immediate vicinity. Multiple and slightly overlapping footprints may be arranged to provide a continuous region of coverage that may extend for considerable distance.

For common cellular telephone systems using frequency division to achieve full duplex operation between base-to-user (forward channel) and user-to-base (reverse channel) communications, no information processing is necessary, and well known, relatively simple and inexpensive hardware may be used at the power line antenna.

However, filtering, amplification, frequency conversion and even demodulation and remodulation onto communication systems which use a different protocol may be included with the local antenna by using well-known devices that provide the appropriate signal or signal carrier treatment. These more complex methods can also allow frequency or isolation between the transport and distribution portions of the present invention with the potential benefit of greater capacity and improved local management.

It will therefore be seen that in its most essential aspect, the distributed antenna system of the present invention includes a transport portion including at least one overhead power line for transmitting system information along the length of the power line; and a distribution portion including at least one local access point disposed along the length of the power line for providing local access to information transported by said transport portion.

Having fully described several embodiments of the present invention, many other equivalents and alternative embodiments will be apparent to those skilled in the art. These and other equivalents and alternatives are intended to be included within the scope of the present invention.

What is claimed as invention is:

1. A distributed antenna system comprising:
one or more distribution points; and
at least one overhead power line for transporting information to said one or more distribution points along the length of said overhead power line.

2. A distributed antenna system as in claim 1, including duplex means for bi-directional transport of information.

3. A distributed antenna system as in claim 3, where said duplex means is at least one duplexer.

4. A distributed antenna system as in claim 3, wherein said duplex means is a telecommunication protocol for bi-directional transmission and reception.

5. A distributed antenna system as in claim 1, wherein energy propagates along said line in a surface wave mode.

6. A distributed antenna system as in claim 1, wherein said system is passive and does not include powered electronic components.

7. A distributed antenna system as in claim 1, further including active electronic components.

8. A distributed antenna system as in claim 7, wherein said active electronic components comprise amplifiers.

9. A distributed antenna system as in claim 7, wherein said active electronic components comprise filtering elements.

10. A distributed antenna system as in claim 7, wherein said active electronic components comprise frequency conversion elements.

11. A distributed antenna system as in claim 7, wherein said active electronic components include amplifiers, filters, and frequency conversion elements.

12. A distributed antenna system as in claim 1, wherein said system has a local access antenna at said one or more distribution points.

13. A distributed antenna system as in claim 1, wherein said system utilizes normal line discontinuities as local access distribution points.

14. A distributed antenna system as in claim 1, further including communication devices for obtaining access by direct communication with one or more of said distribution points.

15. A distributed antenna system as in claim 14, wherein said communication devices are portable or mobile.

16. A distributed antenna system as in claim 14, wherein said communication devices are fixed.

17. A distributed antenna system as in claim 1, wherein said information is conveyed through a multiplicity of information channels.

18. A distributed antenna system as in claim 17, wherein all of said information channels are distributed at each distribution point.

19. A distributed antenna system as in claim 17, wherein at least one of said information channels is not distributed at each distribution point.

20. A distributed antenna system as in claim 17, wherein at least one of said information channels are transported across the entire length of said overhead power line.

21. A distributed antenna system as in claim 17, wherein some of said channels continue on to convey information to a different system of any type.

22. A distributed antenna system as in claim 1, wherein information is not demodulated prior to distribution.

23. A distributed antenna system as in claim 1, wherein information is demodulated and remodulated prior to distribution.

24. A distributed antenna system, comprising:
a transport portion including at least one overhead power line for transmitting system information along the length of said power line; and
a distribution portion including at least one local access point disposed along the length of said power line for providing local access to information transported by said transport portion.

25. The distributed antenna system of claim 24, wherein said power line is divided into one or more segments, each of said segments including one or more spans of power line, and each of said spans having support structures at their respective ends.
